(19) United States
(12) Patent Application Publication
(10) Pub. No.: US 2009/0136834 A1
(43) Pub. Date: May 28, 2009

(54) Method of Constructing an Electrode Assembly

(75) Inventors: Fazlil Ahmode Coowar, Hampshire (GB); Paul David Blackmore, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/270,276

(22) Filed: Nov. 13, 2008

(30) Foreign Application Priority Data
Nov. 27, 2007 (GB) 0723204.4
Mar. 1, 2008 (GB) 0803896.0

(51) Int. Cl. H01M 2/14; H01M 4/04; H01G 9/155

(52) U.S. Cl. 429/127; 429/131; 429/136; 29/623.1; 29/623.2; 361/502

(57) ABSTRACT

An electrode assembly 1 for use in a soft packaged cell such as a battery or supercapacitor comprises a stack 2 of single, discrete cathode elements 4 and single, discrete anode elements 3 alternating with and abutting one another, wherein all the elements of one type are each individually encapsulated in discrete separator envelopes 7 and all the elements of the other type are uncovered, and wherein the electrode assembly 1 is sealed in soft packaging. Sensitive or delicate cathodes or anodes 13, for example, lithium anodes used in primary batteries, may be encapsulated to protect them, and this may facilitate assembly by automated handling equipment.

The present invention relates to electrode assemblies and cells containing the electrode assemblies, and methods for their construction. The invention particularly relates to the construction of soft packaged cells, including batteries or capacitors, especially pouch batteries and supercapacitors. It is of particular application to cells containing a lithium metal anode and lithium-ion cell chemistries.

Soft packaged cells such as the so-called ‘pouch’ batteries, also known as ‘envelope’ or ‘packet’ batteries, are increasingly replacing traditional hard-cased batteries in portable electrical applications. In a typical pouch battery, the battery components are assembled to form a laminated cell structure, and then packaged in a heat-sealable foil. This packaging method offers a light-weight and flexible solution to battery design, and is capable of achieving high energy densities, with the final capacity of the cell being selected according to the desired application.

Pouch batteries can be based on a variety of different cell chemistries, and a range of electrolyte types can be utilised. Lithium primary batteries and secondary batteries, for example, are commonly made according to a pouch design, and dry polymer, gel and liquid electrolytes have all been incorporated into pouch cells. Examples of lithium primary batteries include lithium/carbon monofluoride (LiCFₓ) batteries. Examples of secondary or rechargeable batteries include ones where the active cathode agent is lithium cobalt oxide or lithium manganese oxide or lithium iron disulphide or other mixed metal oxides.

Similar design considerations apply to supercapacitors (or ultracapacitors), which are also becoming available as soft packaged cells to meet the increasing demands of the portable electronics industry. Such supercapacitors are usually based on carbon-carbon, transition metal oxide or conducting polymer chemistries and include both symmetric and asymmetric cell assemblies.

According to a first aspect of the present invention, there is provided an electrode assembly for a soft packaged cell comprising a stack of electrode elements, wherein the stack mainly consists of single, discrete cathode elements and single, discrete anode elements alternating with and abutting one another, and, wherein all the elements of one type are each individually encapsulated in discrete separator envelopes and all the elements of the other type are uncovered.

No other separator means need to be disposed inside the stack in order to separate adjacent elements. The stack of electrode elements is usually surrounded by an outer wrap of separator material or other suitable insulating material to form the electrode assembly.

Either the separator envelopes are formed from a solid electrolyte, for example, a polymer electrolyte, or the separator is formed from a semi-permeable separator membrane, for example, a porous polymer sheet-like material. In this case, the subsequent outer packaging of the resulting cell, for example, a pouch, also contains a liquid electrolyte added prior to sealing the packaging, which soaks into the separator for ion transfer.

The electrode elements will usually be in the form of thin, flat plates arranged with their faces abutting (i.e. facing or lying against) one another. The anode and cathode elements are each normally double-sided, except for the elements disposed at each end of the stack. A double-sided electrode is one with active electrode material disposed on both the faces of a single sheet or plate (e.g. current collector) and in the current arrangement these maximise cell efficiencies. Similarly, it is more efficient if the two outermost electrodes have only a single active face; where the uncovered set of electrodes provide the outermost electrodes, cell weights are further minimised.

The encapsulated electrode elements may be formed of sensitive or difficult to handle materials, for example, pressure sensitive, light or touch sensitive, or moisture sensitive active electrode materials or ones that are fragile or easily deformed. For example, the electrodes may contain lithium metal, which is moisture sensitive and soft and malleable and has a tendency to stick together. Encapsulation of the latter enables or facilitates automated assembly.

Primary cells are advantageously constructed in accordance with the present invention with encapsulated lithium anodes and bare cathodes. Secondary cells having sensitive electrodes, such as, for example, lithium iron disulphide cathodes, are also advantageously encapsulated in accordance with the present invention.

Both types of electrode element are discrete elements, that is to say, the anode elements and cathode elements are separate entities that are not structurally joined or linked to themselves or to the other elements in any way, except by virtue of their subsequent electrical connections. (The respective sets of anode and cathode tags will normally be crimped or welded together for electrical connectivity.) In addition, the separator envelopes are discrete separate envelopes, that is to say, they are not joined to each other or anything else. Thus, the cell is assembled from separate discrete components, as opposed to prior art cells, which have been assembled by the use of, for example, cathode elements located in a continuous band of enveloping separator material.

The separator envelopes may be preformed in their final shape or formed from sheets subsequently sealed or folded. They may be four sided (depending on the electrode shape), and are usually rectangular. They should be open on at least one side where electrolyte ingress is required, and may be open on two or three sides; conveniently, the tabs will protrude through one open end. Preferably, they are only open on two opposite sides. Thus, they may be folded and/or sealed on just 1 edge to form a loose pamphlet, or more usually, folded or otherwise closed or sealed on 2, or 3 edges thereof. Preferably, the envelopes are formed from sheets (roughly double the size of the electrode to be encapsulated) folded on one edge only, and, in that case, the edge opposite the fold is preferably sealed. Sealing may occur by heat sealing, gluing, taping, ultrasonic bonding or other suitable methods that allow a wallet or pouch to form in which the electrode is a reasonably secure fit. Alternatively, the envelopes may be formed by sealing two adjacent edges of, for example, two separate sheets (each being of slightly bigger area than the electrode to be encapsulated). To maximise the open area of the envelope through which soaking of the electrolyte may occur, preferably two opposite sides of the separator envelopes have closed ends and the other two opposite ends are open.

Although usually single layer to maximise current flow, the envelopes may have overlapping sections or comprise double envelopes nested one in the other, possibly of different separator materials, for additional safety. The separator envelopes may also comprise (unclosed or unsealed) wraps of a separator sheet or band, for example, a spiral wrap, providing that each separator is discrete and not linked to a neighbouring separator or electrode.

The electrode assembly is intended for use in a soft packaged cell, as opposed to a hard, rigid casing. The cell is preferably thin and flexible and may be a battery, a supercapacitor, or similar electrochemical device, including hybrid devices.

In the case of a battery, the cell will usually be a pouch battery. The electrochemical cell may be of a suitable size and weight for powering portable electrical equipment or small handheld devices. The cell may be any size from for example a low capacity cell of 10 mAh up to a large capacity of 50 Ah. The cell may be a primary cell and, in that case, the encapsulated electrode may be a lithium metal anode.

The cell may be a secondary or rechargeable cell and the encapsulated electrode may be formed of lithium cobalt oxide, lithium manganese oxide or lithium iron disulphide.

The present invention further provides a method of assembling an electrode assembly for a soft packaged cell comprising a plurality of anode elements and a plurality of cathode elements, comprising the steps of:—

forming a stack substantially consisting of alternating single, discrete cathode elements and single, discrete anode elements abutting one another, wherein all the elements of one type are each individually encapsulated in discrete separator envelopes and all the elements of the other type are not encapsulated.

Usually, no other separator means are disposed inside the stack in order to separate adjacent elements.

Depending on the final cell, a stack might comprise two to forty electrode pairs, more usually four to twenty pairs, while most cells will be formed of five to ten electrode pairs.

The method may involve the step of applying a wrap of separator around the final cell stack, which may be secured in place, for example, by heat sealing, glue or tape (usually polyimide tape). This may be automated where the stacking process is automated. Usually, an additional step will follow of connecting the respective anode and cathode tabs to form two tags for the external electrical connections.

The method may comprise the further step of sealing the electrode stack in packaging, e.g. a pouch, to form a cell, for example, a battery or supercapacitor. The method may further comprise the step of adding liquid electrolyte to the packaging, prior to sealing, where a solid electrolyte has not been used as a separator.

The method may comprise successively placing the alternating anode and cathode elements adjacent one another, one by one, as a series of separate individual steps, to form the stack. For automated assembly, the different types of electrode may be stored in respective nests.

The method will usually need to be conducted in a dry room in order to reduce moisture ingress into the cells.

The method may involve the use of automated handling equipment. The present invention provides a method by which sensitive electrodes (such as lithium foil) can be encapsulated prior to being handled by mechanical assembly equipment. Pre-encapsulation of the electrodes using the separator can also protect the electrodes from damage, moisture ingress and contamination and improve final cell performance.

An automated method may involve initially creating individual supply stacks consisting of the same type of elements, preferably located in respective nests, wherein the stack of the final cell is created by the automated handling equipment transferring elements from the supply stacks in a particular order to the stack of the final cell. In the case of sensitive electrodes, it has been found that automated handling equipment can handle and stack such pre-encapsulated electrodes, when assembled in a supply stack, more easily and efficiently, and with less damage than bare electrodes.

All of the above-mentioned steps may be automated.

The invention will now be described in more detail, by way of example only, with reference to the accompanying drawings, in which:

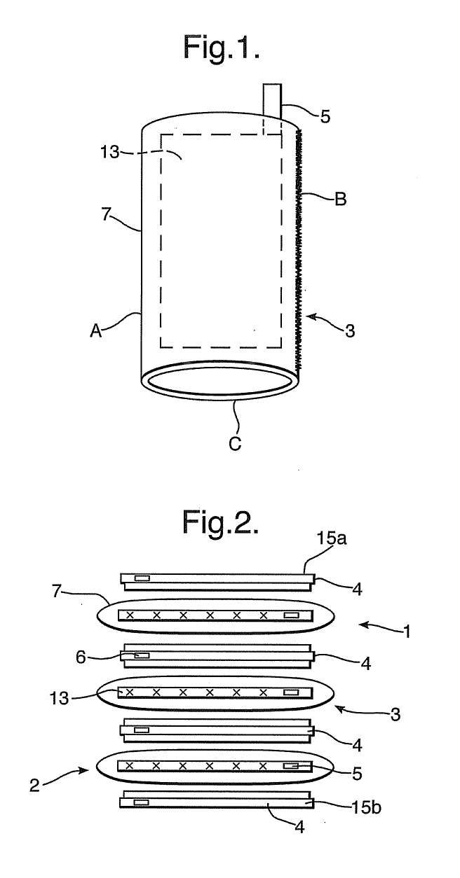

FIG. 1 is a plan view of an encapsulated anode according to the present invention;

FIG. 2 is an end view of an electrode assembly according to the present invention;

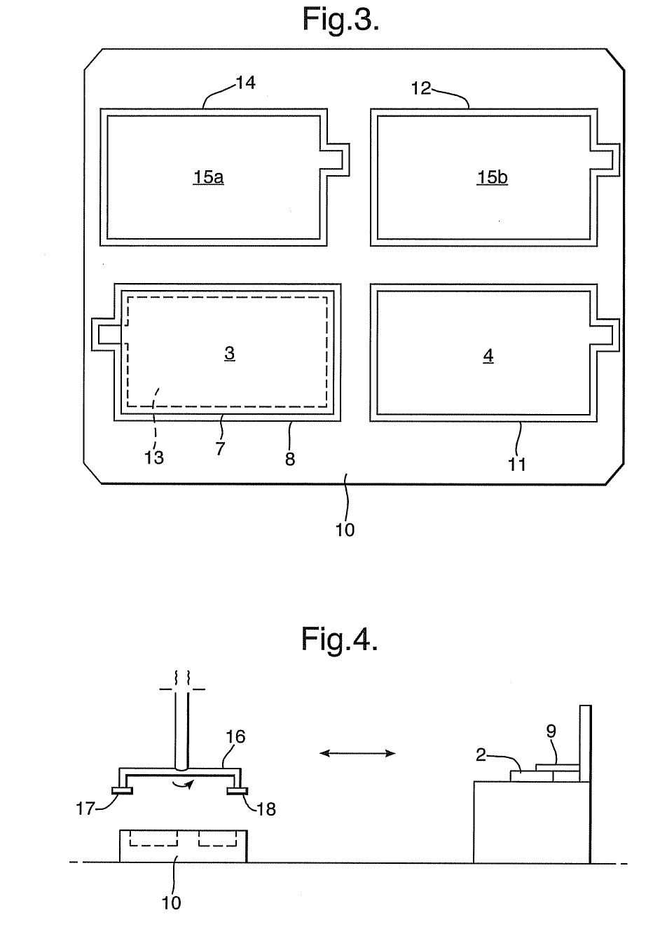

FIG. 3 is a schematic plan view showing nests containing respective stacks of the different types of electrodes prior to assembly;

FIG. 4 is a schematic side view of automated assembly apparatus; and,

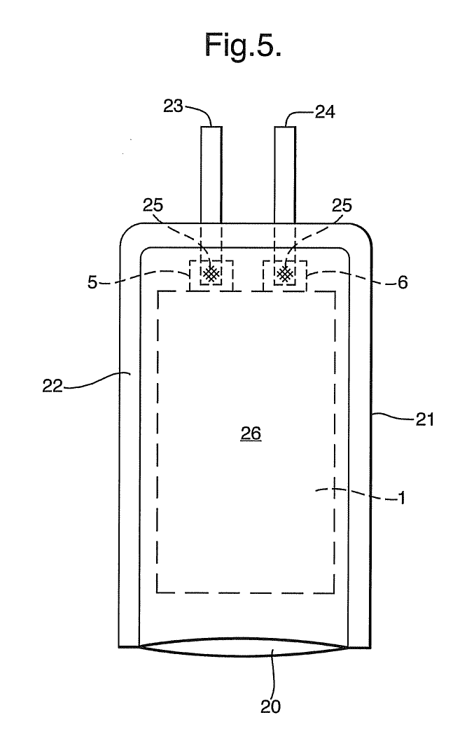

FIG. 5 is a plan view of a pouch containing the electrode assembly of FIG. 2.

FIG. 2 shows an electrode assembly 1 of a primary lithium carbon monofluoride pouch cell intended for use in portable equipment.

The electrode assembly 1 is formed from a stack 2 of alternating anode and cathode elements 3,4. The anode elements 3 have projecting tabs 5 to act as current collector terminals, which tabs are aligned with one another. The cathode elements 4 have similar tabs 6 aligned with one another on the other side of the end of the stack 2. Both sets of tabs 5,6 protrude from the same end of the stack. The anode elements 3 each comprise an anode 13 singly encapsulated in a wallet or envelope 7 of separator material. In this case, the wallet 7 has been folded on side A and heat sealed on side B, leaving the other two sides open. (This is preferred when an electrolyte filling step is to be used.) The cathode elements 4 are left unwrapped i.e. bare. No other separator material is present inside the stack to separate the abutting electrode faces. Prior to assembly, the anodes and cathodes and separator envelopes are all separate components (i.e. not linked or attached to themselves or each other) and hence, are individually and independently manoeuvrable, for example, by robot arms. The top and bottom electrode elements of the stack 2 are preferably of the same type, which type is preferably the uncovered set. Ideally, they may be single sided electrodes 15a, 15b in order to avoid an excess of active material.

Both electrode elements 3,4 usually comprise current collectors coated with active electrode material. Turning to the anode element 3, the anode current collector preferably comprises a metal mesh, grid, strips or gauze, and is used to provide the external anodic, or negative, contact to the cell. Preferably the anode collector comprises a copper mesh.

The cathode collector provides the external cathodic or positive contact to the cell and preferably comprises aluminium foil. Other suitable collector materials are well known in the art.

In the present cell, the anode material is lithium. The anode collector and lithium together form an integral anode 13, wherein lithium is present on both sides of the anode collector. Ideally, the integral anode 13 is formed by pressing lithium foil onto a mesh, most suitably a copper mesh, such that the lithium occupies the openings of the mesh. Safety is of particular concern in the case of larger capacity pouch cells, and hence, fragmentation of lithium metal as the anode is consumed should be minimised. (Prior art pouch cells containing liquid electrolyte have been known to present a fire hazard due to free lithium coming into contact with flammable organic solvent.) By using an integral anode in which the lithium is held on a solid substrate, in this case the anode collector, the liberation of fine particles of pyrophoric lithium into the cell can be substantially prevented. A copper foil current collector tab 5 was cold welded onto the lithium coated copper mesh to act as the terminal.

For many cathode materials of choice, such as manganese dioxide and carbon monofluoride, the cathode material is coated onto the cathode collector as a slurry prior to assembling the precursor electrode assembly, thus forming an integral cathode element 4, preferably with an integrally formed tab 6. By using integral electrodes and integral projecting tabs, cell construction is simplified, and made more robust.

The purpose of the separator 7 is to separate the anode from the cathode, to carry the electrolyte and to act as a safety shut-down separator should the pouch cell overheat. For certain types of electrolyte, such as a dry polymer electrolyte or a polymer gel electrolyte, the electrolyte may itself function as the separator. For other types of electrolytes, in particular for a liquid electrolyte, the separator may comprise a semi-permeable or porous membrane which is soaked with the electrolyte.

In this case, the separator 7 is dried and cut into sheets approximately double the size of the anode 13 and each separator sheet is folded at side A around the anode 13 and heat sealed at opposite side B, prior to insertion of the anode. Ideally, the wallet is a sufficiently tight fit around the anode that the anode cannot easily slide towards or away from either open end. Once all the anode and cathode elements 3,4 are individually prepared they may be assembled into a stack 2 as shown in FIG. 2 either manually or by using automated handling equipment 16, as shown in FIG. 4. Referring to FIG. 5, the stack 2 is then wrapped in a band of separator 26 to form the precursor electrode assembly 1. The anode tabs 5 and cathode tabs 6 are respectively welded at area 25 to two outer tabs 23, 24 to form the terminals. Then, an aluminium foil, heat sealable laminate sheet is formed around the electrode assembly 1 and heat sealed in a peripheral area 22 on three sides to form a pouch 21, with the side 20 opposite the tabs left open for the electrolyte-filling step.

In the present LiCFₓ cell, in use, the separator 7 comprises a semi-permeable membrane soaked in a liquid electrolyte. The semi-permeable membrane may be a tri-layer polymer laminate, for example a polypropylene-polyethylene-polypropylene laminate.

Suitably, the liquid electrolyte comprises an organic carbonate, such as, for example, one or more of propylene carbonate, ethylene carbonate, dimethyl carbonate, diethyl carbonate and ethyl methyl carbonate, and a lithium salt, such as, for example, lithium bis-oxalato borate and lithium tetrafluoroborate, lithium hexafluorophosphate, lithium hexafluoroarsenate, lithium perchlorate, or any mixture thereof. In the electrolyte filling step, the liquid electrolyte is injected into the pouch and needs to permeate the entire length of the respective separator membranes 7 so as to yield an efficient cell. The inventors have found that open individual anode envelopes aid this process, leading to more rapid and more complete permeation. After degassing, opening 20 is vacuum heat sealed to form the pouch battery.

Although described in respect of a primary cell, the above construction method is equally applicable to secondary cells, especially lithium ion cells, where the anode is an intercalation material as well (e.g. graphite—pure lithium anodes are unsatisfactory due to dendrite growth) and the lithium ions are exchanged between the intercalation materials of the respective electrodes during charging and discharging.

Equally, in the case of sensitive cathodes, for example, a secondary cell with Li2FeS2 cathodes, these may be wrapped in the envelopes while the (more stable) lithium/graphite anodes are uncovered.

The following Examples illustrate the invention:—

### EXAMPLE 1

A primary lithium carbon monofluoride cell was manufactured in the following way under dry room conditions:

Cathodes were prepared by, first, grinding and mixing intimately carbon monofluoride and a conductivity additive (carbon black). A binder solution was prepared by dissolving polyvinylidene fluoride (PVDF) in N-methyl pyrollidinone. Then a paste was formed from the CFₓ mixture and the PVDF solution.

Aluminium foil sheets were cleaned and the cathode paste was coated onto each side of the Al foil leaving an uncoated margin. The sheets were then dried and individual cathodes were stamped out, to give double sided cathodes 4, each having an uncoated tab 6 to act as a current collector terminal.

Next, similar sized anodes 13 were each prepared using a laminate formed from copper mesh and a single layer of lithium foil, the latter attached from one side of the mesh and pressed through the mesh so as to occupy the openings in the mesh to form a double sided lithium coated anode 13. Copper foil current collectors were cold welded onto the copper mesh to act as terminals 5.

A safety separator (Celgard™ 2340) was cut into sheets roughly double the size of the anodes. These were folded in to envelopes 7 and heat sealed on one (B) or two edges (B,C) to form envelopes.

The cell was fabricated by first placing the lithium anodes 13 into the envelopes 7, with their uncoated tabs 5 protruding. The encapsulated anode 3 and bare cathodes 4 were then stacked alternately, manually, one above the other, to form a stack 2, with the cathode tabs 6 aligned above one another and the anode tabs 5 spaced therefrom and also aligned with one another. No other separators or other insulating means were placed between the individual electrodes. The stack 2 was secured together with an outer band of separator wrapped therearound. After preparing the terminals, a heat sealable foil sheet was cut and trimmed to the correct dimensions and then heat sealed around three sides to form the cell packaging.

Lithium tetrafluoroborate was dissolved in a mixture of anhydrous propylene carbonate and anhydrous dimethoxyethane, to give a 1M solution of LiBF₄ electrolyte. The electrolyte was injected into the pouch cell and then the cell was sealed.

Upon testing, the cell demonstrated acceptable performance.

The above manual assembly method may be advantageously automated for large scale production. In a further improved method, the electrodes were assembled by an automated assembly machine 16. In this case, the encapsulated anodes 3 and bare cathodes 4 are each stacked in individual nests (nest 11 containing stacked double sided cathodes, and nest 8 containing a stack of double sided anodes), and a robot arm 16 retrieves the individual electrodes alternately, one at a time, from their respective nests, before stacking them under grip 9 to form the stacked assembly.

In either method, the top and bottom electrodes placed at each end of the stack are single sided bare cathodes 15a and 15b. In the automated method, the nest will include two further nests 14, 12, for single sided cathodes 15a and 15b, respectively. To avoid cross-contamination, a swivelling robot arm 16 was used having two suction heads 17 and 18, one solely for manipulating the encapsulated anodes, while the other was used to move the three types of cathode elements.

Assembly using the automated handling equipment was found to be efficient and reliable.

### EXAMPLE 2

A nominal capacity 1 Ah (Ampere hour) primary lithium carbon monofluoride cell with encapsulated anodes was manufactured in the following way:

Each cathode sheet was prepared by, first, grinding and mixing intimately 42 g carbon monofluoride and 3.2 g of conductivity additive (carbon black). A binder solution was prepared by dissolving 4.8 g of polyvinylidene fluoride (PVDF) in N-methyl pyrollidinone. Then a paste was formed from the CFx mixture and the PVDF solution. Battery grade medium temper aluminium foil was coated with the cathode paste to a depth of 570 micron, so as to give a cathode capacity of 12.6 to 13.6 mAh/cm². Each sheet was then dried to give a final cathode composition by weight of 84:9.6:6.4 w/o CFx:PVDF:conductivity additive, and a final coating thickness of 185 micron. This coating process was repeated on the other side of the aluminium foil. Each cathode sheet was rolled in a calendar machine to compact the coating and layers were cut 31 mm by 48 mm plus an integral uncoated tab which was 7 mm wide by 20 mm long. Single sided coated versions of these cathode sheets were prepared to be used as the outer cell stacks.

Next, each anode was prepared using a laminate formed from copper mesh and a single layer of lithium foil, the latter attached from one side of the mesh to form an integral laminate with two active faces (the lithium occupying the mesh holes). Each laminate was cut to a length of 46 mm and a width of 29 mm, and a copper tab 7 mm wide and 20 mm long was cold welded to the lithium. The thickness of the copper mesh was 100 micron and the lithium foil thickness was 132 micron, giving an anode capacity of 27.2 mAh/cm².

A reel of safety separator (Celgard™) 50 mm wide was dried overnight under vacuum and lengths cut off more than 60 mm long. These were folded around the lithium anodes with the fold along the long edge of the anode. The separator was sealed together along the opposite edge to the fold using a heat sealing bar and the excess separator trimmed off.

Layers of single sided cathode, top and bottom, double sided cathodes, and double-faced anodes encapsulated in separator material were fed into a cell nest in preparation for them to be assembled robotically into a cell stack comprising three layers of anode, two layers of double sided cathode, and two layers of single sided coated cathode, as shown schematically in FIG. 2.

The stack was assembled by a robot and then secured together with an outer band of separator wrapped therearound.

The robot assembled cell stack then had its cell tabs trimmed to the same length and a copper outer tab ultrasonically welded to the copper anode tabs, and a nickel outer tab ultrasonically welded to the aluminium cathode tabs. This dry cell stack assembly was then placed in a pouch made from a heat sealable aluminium laminated film (D-EL40H, DNP Japan), which was sealed and/or folded on all sides except the end opposite the protruding tabs.

An electrolyte solution comprising 1M solution LiBF4 dissolved in a mixture of anhydrous propylene carbonate and anhydrous dimethoxyethane was injected into the cell and the cell was vacuum sealed.

### EXAMPLE 3

A nominal capacity 1 Ah secondary lithium-ion cell with encapsulated cathodes was manufactured in the following way:

A commercially available lithium-ion cobalt oxide cathode electrode, double sided coated onto aluminium foil current collector, was cut 128 mm by 63 mm, and included an integral uncoated tab which was 7 mm wide by 20 mm long.

A commercially available lithium-ion double sided graphitic anode coated on a copper foil current collector was cut to a length of 128 mm and a width of 63 mm, plus an integral uncoated tab of copper which was 7 mm wide by 20 mm long. Single sided coated versions of these anode sheets were prepared to be used as the outer electrodes on the top and bottom of the cell stacks.

A reel of safety separator (Celgard™ 2340) 130 mm wide was dried overnight under vacuum and lengths cut off more than 128 mm long. These were folded around the lithium-ion cathode electrodes with the fold along the long edge of the cathode. The separator was sealed together along the opposite edge to the fold using a heat sealing bar and the excess separator trimmed off.

Layers of single sided anode, top and bottom, double sided cathodes encapsulated in separator material, and double sided anodes were fed into a cell nest in preparation for them to be assembled into a cell stack comprising three layers of encapsulated cathode, two layers of double sided anode, and two layers of single sided coated anode as shown again schematically in FIG. 2, except that the electrodes are reversed with the cathodes being encapsulated.

The stack was assembled by a robot and then secured together with an outer band of separator wrapped therearound.

The robot assembled cell stack then had its cell tabs trimmed to the same length and a copper outer tab ultrasonically welded to the copper anode tabs, and a nickel outer tab ultrasonically welded to the aluminium cathode tabs. This dry cell stack assembly was then placed in a pouch made from a heat sealable aluminium laminated film (D-EL40H, DNP Japan).

An electrolyte solution comprising 1M solution LiPF6 dissolved in a mixture of anhydrous organic carbonates was injected into the cell and the cell was vacuum sealed.

### EXAMPLE 4

An asymmetric supercapacitor with encapsulated cathodes was manufactured in the following way:—

A commercially available, nickel oxyhydroxide cathode electrode, double sided coated onto a nickel mesh current collector, was cut 128 mm by 63 mm and included an integral uncoated tab which was 7 mm wide by 20 mm long.

A commercially available polarizable double sided activated carbon anode coated on nickel mesh current collector was cut to a length of 128 mm and a width of 63 mm, plus an integral uncoated tab of nickel which was 7 mm wide by 20 mm long. Single sided coated versions of these anode sheets were prepared to be used as the outer electrodes on the top and bottoms of the cell stacks.

A reel of safety separator 130 mm wide and lengths cut off more than 128 mm long was used. These were folded around the nickel oxyhydroxide cathode electrodes with the fold along the long edge of the cathode. The separator was sealed together along the opposite edge to the fold using a heat sealing bar and the excess separator trimmed off.

Layers of single sided anode, top and bottom, double sided cathodes encapsulated in separator material, and double sided anodes were fed into a cell nest in preparation for them to be robotically assembled into a cell stack comprising three layers of encapsulated cathode, two layers of double sided anode, and two layers of single sided coated anode. This is again depicted in FIG. 2, except again in this case with the cathodes being encapsulated.

The stack was assembled by a robot and then secured together with an outer band of separator wrapped therearound.

The robot assembled cell stack then had its cell tabs trimmed to the same length and a nickel outer tab ultrasonically welded to the nickel anode tabs, and a nickel outer tab ultrasonically welded to the nickel cathode tabs. This stack assembly was then placed in a polypropylene case.

An electrolyte solution comprising of 6M KOH was injected into the cell and the cell was hermetically sealed.

The above examples have been disclosed for illustrative purposes, and those skilled in the art will appreciate that various modifications, additions and substitutions are possible, without departing from the scope of the invention as disclosed in the accompanying claims.

1. An electrode assembly for a soft packaged cell comprising a stack of electrode elements, wherein the stack includes a first type of single, discrete cathode elements and a second type of single, discrete anode elements, wherein all the elements of one type are each individually encapsulated in discrete separator envelopes and all the elements of the other type are uncovered, and wherein said single, discrete cathode elements and said single, discrete anode elements alternate with and face one another in said stack.

2. An electrode assembly as claimed in claim 1, wherein the anode and cathode elements are each double-sided, except for electrode elements disposed at each end of the stack.

3. An electrode assembly as claimed in claim 2, wherein the electrode elements disposed at each end of the stack are of the uncovered type.

4. An electrode assembly as claimed in claim 1, wherein the stack of electrode elements are surrounded by an outer wrap of separator material to form the electrode assembly.

5. An electrode assembly as claimed in claim 1, wherein the encapsulated electrode elements are lithium metal anodes.

6. An electrode assembly as claimed in claim 1, wherein the separator envelope is formed from a solid electrolyte.

7. An electrode assembly as claimed in claim 1, wherein the separator envelope is formed from a semi-permeable separator membrane.

8. An electrode assembly as claimed in claim 1, wherein the separator envelopes are four sided and open on one, two or three sides.

9. An electrode assembly as claimed in claim 8, wherein the separator envelopes are formed with only two opposite open sides.

10. A soft packaged cell comprising an electrode assembly as claimed in claim 1.

11. A cell as claimed in claim 10, which cell is a thin, flexible, soft packaged battery or supercapacitor.

12. A method of assembling an electrode assembly for a soft packaged cell including a stack of electrode elements, comprising the steps of:—
providing a first type of single, discrete cathode elements and a second type of single, discrete anode elements, wherein all the elements of one type are each individually encapsulated in discrete separator envelopes and all the elements of the other type are not encapsulated; and,
forming a stack from said first type and said second type of elements, wherein said single, discrete cathode elements and said single, discrete anode elements alternate with and face one another in said stack.

13. A method of assembling an electrode assembly as claimed in claim 12, further involving the step of applying a wrap of separator material around the final cell stack to form the electrode assembly.

14. A method of assembling an electrode assembly as claimed in claim 12, the method comprising successively placing the alternating anode and cathode elements so as to face one another, one by one, as a series of separate individual steps, to form the stack.

15. A method of assembling an electrode assembly as claimed in claim 12, wherein the method involves the use of automated handling equipment.

16. A method of assembling an electrode assembly as claimed in claim 15, wherein the method involves providing supply stacks consisting of the same type of electrode elements located in respective nests, and using the automated handling equipment to transfer electrode elements from the supply stacks in a particular order to the final stack.

17. A method of assembling an electrode assembly as claimed in claim 12, further comprising the step of sealing the electrode stack in soft packaging to form a battery cell or supercapacitor cell.

18. A method of assembling an electrode assembly as claimed in claim 12, wherein the anode and cathode elements are each double-sided, except for electrode elements disposed at each end of the stack.

19. A soft packaged cell comprising an electrode assembly encased in thin, flexible packaging, wherein the electrode assembly comprises a stack of electrode elements, wherein the stack consists essentially of a first type of single, discrete cathode elements and a second type of single, discrete anode elements, wherein all the elements of one type are each individually encapsulated in discrete separator envelopes and all the elements of the other type are uncovered, and wherein said single, discrete cathode elements and said single, discrete anode elements alternate with and face one another in said stack.
